(19) United States
(12) Patent Application Publication
(10) Pub. No.: US 2003/0075348 A1
(43) Pub. Date: Apr. 24, 2003

(54) Rocker button activated forward/reverse mechanism for a power tool

(75) Inventors: Edward C. Eardley, Easton, PA (US); Patrick S. Livingston, Easton, PA (US); Michael J. Loomis, Center Valley, PA (US); Scott D. Price, Lebanon, NJ (US)

Correspondence Address: Leon Nigohosian, Jr., Michael Best & Friedrich LLP, Suite 360, 3773 Corporate Parkway, Center Valley, PA, 18034, US

(73) Assignee: Ingersoll-Rand Company, Woodcliff Lake, NJ (US)

(21) Appl. No.: 10/040,080

(22) Filed: Oct. 24, 2001

(51) Int. Cl. B27C 3/08

(52) U.S. Cl. 173/169

(57) ABSTRACT

A forward/reverse mechanism and a pneumatic pressure operated power tool incorporating the mechanism are provided. The mechanism includes a rocker button having two lever portions and an actuator disposed next to one lever portion or a pair of actuators disposed next to both lever portions for engaging and rotating opposite sides of a periphery of a rotary valve spool for effecting rotation of the rotary spool in response to movement of the rocker button.

### BACKGROUND OF THE INVENTION

This invention relates generally to reversing valves for power tools and more particularly to a reversing valve for a pneumatically operated hand held power tool.

In the past, reversing valves for power tools have been complicated in structure or difficult or inconvenient to operate. An improved rotary spool reversing valve is described in commonly assigned U.S. Pat. No. 5,199,460 to Geiger, the disclosure of which is incorporated herein by reference. The reversing valve described in the '460 patent is operated in rotation by two parallel opposed push buttons. The spool is positioned in line with the incoming air passage permitting incoming air to flow axially through the spool directly to forward or reverse motor ports with a minimum of pressure loss. Thumb operation of the push buttons in a pistol grip tool permits convenient one hand operation with simple molded mechanisms providing economy and ease of operation. Although effective, the push buttons generally require a user to lift the thumb when switching between push buttons in order to change direction of the motor ports.

The foregoing illustrates limitations known to exist in present reversing valves for power tools. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

A forward/reverse mechanism and a pneumatic pressure operated power tool incorporating the mechanism are provided. The mechanism includes a rocker button having two lever portions and an actuator disposed next to one lever portion or a pair of actuators disposed next to both lever portions for engaging and rotating opposite sides of a periphery of a rotary valve spool for effecting rotation of the rotary spool in response to movement of the rocker button.

The foregoing and other aspects will become apparent from the following detailed description of the invention when considered in conjunction with the accompanying drawing figures.

### BRIEF DESCRIPTION OF THE DRAWINGS

FIG. 1 is a partially sectioned elevation view of a rocker button activated forward/reverse mechanism for a power tool according to the present invention installed in a pneumatic operated power tool;

FIG. 2 is an end elevation view showing the convenient location of the rocker button according to the present invention;

FIG. 3 is a cross sectional view taken at Section 3-3 of FIG. 1 showing the rocker button and actuators according to the present invention;

FIG. 4 is a distributor face plate of a conventional pneumatic tool;

FIG. 5 is an end view of a distributor of a conventional rotary valve spool;

FIG. 6 is a sectioned side elevation of the rotary valve spool taken at Section 6-6 of FIG. 5;

FIG. 7 is the cross-sectional view of FIG. 3 showing a lever portion of the rocker button depressed in a first direction;

FIG. 8 is the cross-sectional view of FIG. 3 showing a lever portion of the rocker button depressed in a second direction;

FIG. 9 is a planar view showing the assembly of a rocker button activated forward/reverse mechanism for a power tool according to the present invention;

FIG. 10 is an planar view showing an assembled rocker button activated forward/reverse mechanism for a power tool according to the present invention;

FIG. 11 is an planar view showing an assembled rocker button activated forward/reverse mechanism having a single actuator according to the present invention; and

FIG. 12 is a planar view showing an alternate actuator configuration for use with a rocker button according to the present invention.

### DETAILED DESCRIPTION OF THE PREFERRED EMBODIMENTS

The invention is best understood by reference to the accompanying drawings in which like reference numbers refer to like parts. It is emphasized that, according to common practice, the various dimensions of the diaphragms and the associated component parts as shown in the drawings are not to scale and have been enlarged for clarity.

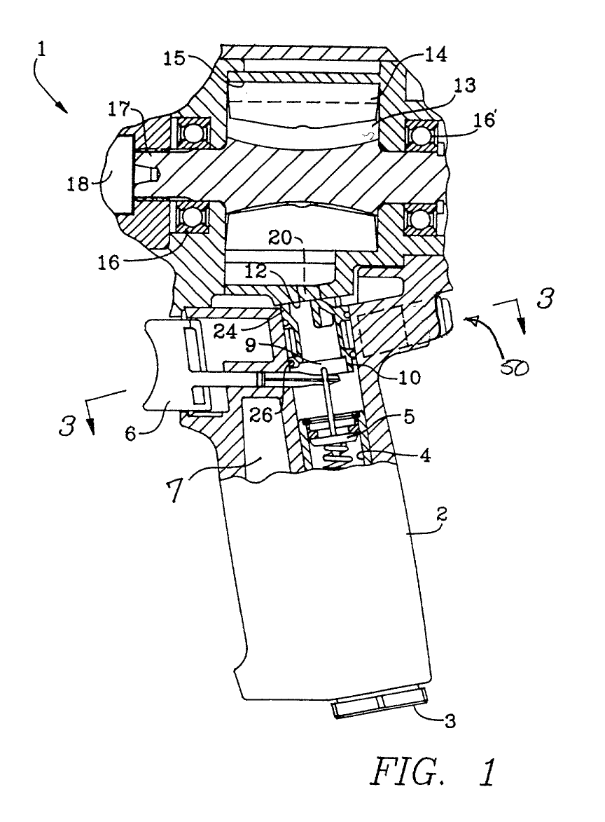

Referring now to the drawings, shown in FIG. 1, a partial power tool 1 is shown in partial section. The power tool 1 is provided with a handle 2 having a pneumatic fluid or air inlet 3 for providing motive fluid to a pneumatic operated motor or air motor 13. Air is supplied to the air motor through air inlet passageway 4. A tilt valve 5 is operated by means of a trigger 6 to admit pressure fluid to a chamber 9. valve for selectively distributing pressure fluid to a forward supply port 20 or optionally a reverse supply port 21 (shown hidden behind the forward supply port 20) at a position of approximately 180 degrees opposite the forward port in a planar plate 12 from the circular end of chamber 9.

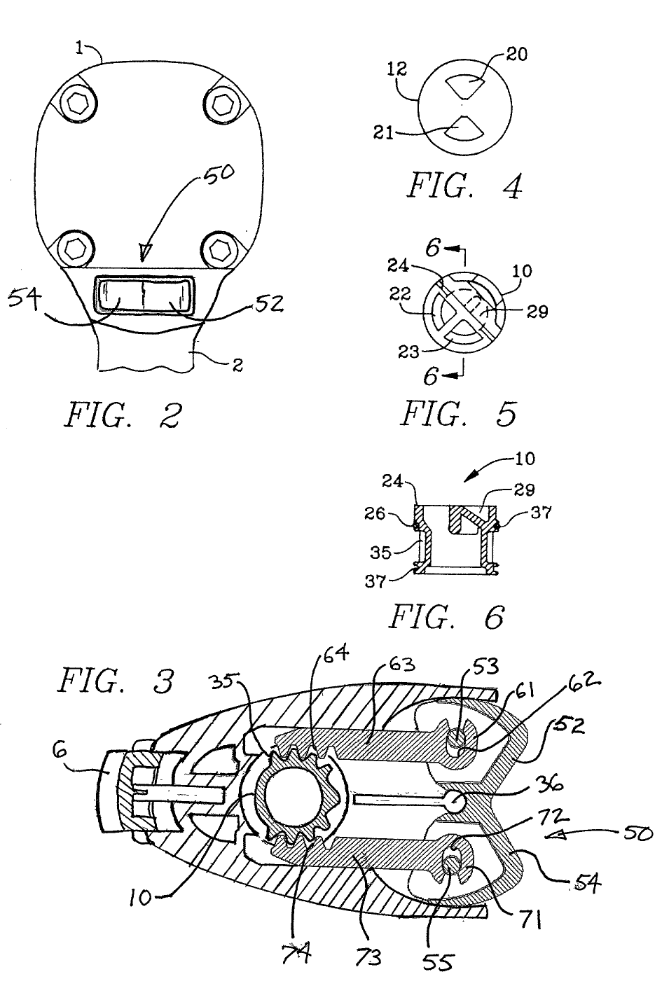

The rotary valve spool 10 is provided with a planar segmented end (shown in a top view of the rotary valve spool in FIG. 5) which slidingly cooperates with the planar surface of planar plate 12 (shown in a bottom view of the planar plate 12 in FIG. 4). As shown in FIG. 3, which is a cross section taken at Section 3-3 of FIG. 1, the rotary valve spool 10 is formed with a plurality of pinion gear teeth 35 about its approximate midsection. As shown in FIG. 5, rotary valve spool 10 contains forward and reverse passageways 22 and 23, and a notched area 29 which handles secondary exhaust, as will be described later in greater detail.

Forward and reverse passageways 22 and 23 are located approximately 90 degrees apart and forward and reverse supply ports 20, 21 are located approximately 180 degrees apart, such that by rotating the rotary valve spool 10 approximately 90 degrees will bring one or the other passageways 22, 23 in contact with one of the supply ports 20, 21 leading to either the forward or reverse chambers of the motor.

In operation, air entering the forward supply port 20 or reverse supply port 21 selectively proceeds to drive the air motor 13 in forward or reverse direction as the air is expanded against motor vanes 14 in the motor cylinder 15. The motor rotates on bearings 16 and 16′ to drive an output shaft 17 which in turn drives a rotating shaft 18 of the working output device.

Returning now to the cooperating face between the rotary valve spool 10 and the planar plate 12, air passing the rotary valve spool 10 from air inlet passageway 4 in chamber 9 is directed to two face termination passageways 22, 23. Partition 24 which forms the face seal of the rotary reversing valve is in the form of a semicircular circle having the two pie-shaped passageways 22 and 23 extending to the cooperating valve surface. The passageways 22, 23 selectively register with either forward port 20 or the reverse supply port 21 in the planar plate 12. The notched area 29 registers with corresponding forward supply port 20 or reverse supply port 21 to bleed secondary exhaust which prevents recompression. The notched area 29 allows the secondary exhaust to enter main exhaust cavity 7.

It may now be appreciated by one skilled in the art that rotating the rotary valve spool 10 will accomplish direction of motive fluid to either forward or reverse the motor.

According to the present invention, shown in FIGS. 1-3 and 7-11 is a rocker button 50 having two lever portions 52 and 54 located on either side of a post receiving slot 51 configured for attachment to a cylindrical post 36 located in power tool 1. Located within each lever portion 52, 54 are posts 53, 55 as shown in FIGS. 3 and 7-9.

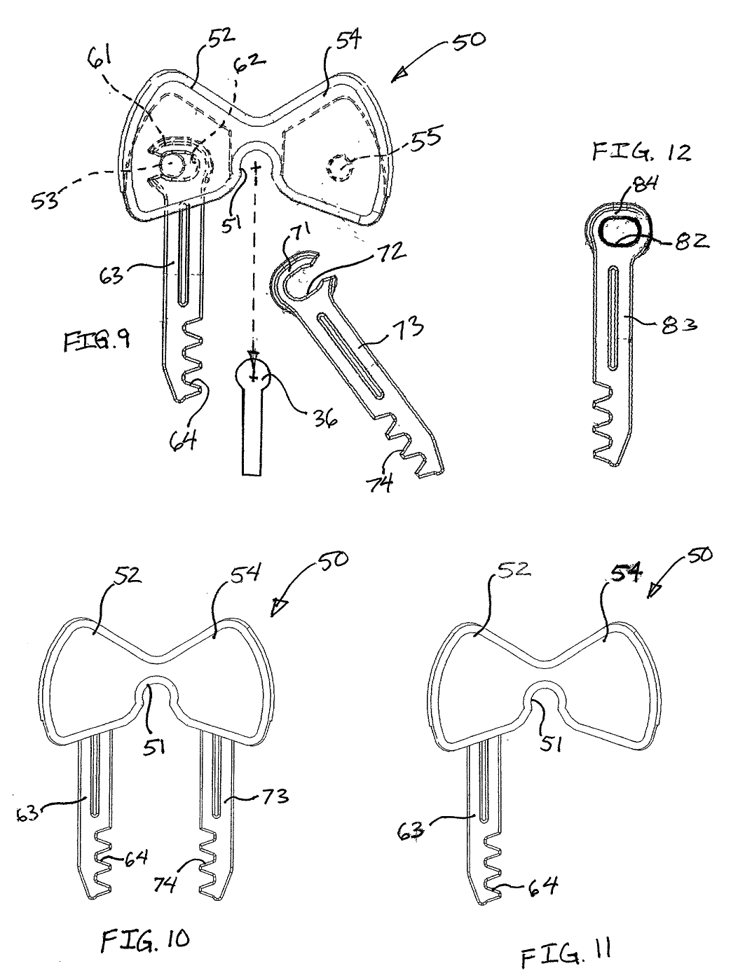

Associated with each lever portion 52, 54 are actuators in the form of rack portions 63, 73 having rack teeth 64,74, respectively, which cooperate with pinion teeth 35 on rotary valve spool 10. Preferably, rack portions 63, 73 are attached to posts 53, 55 of lever portions 52, 54 via integrally provided clips 61, 71. As shown in FIG. 9, rack portion 63 is attached to rocker button 50 by snapping clip 61 over post 53 and clip 71 over post 55 to form a double pinion-rack assembly shown in FIG. 10. Completed assembly is achieved by inserting rack portions 63, 73 into pneumatic tool 1 and snapping post receiving slot 51 over cylindrical post 36.

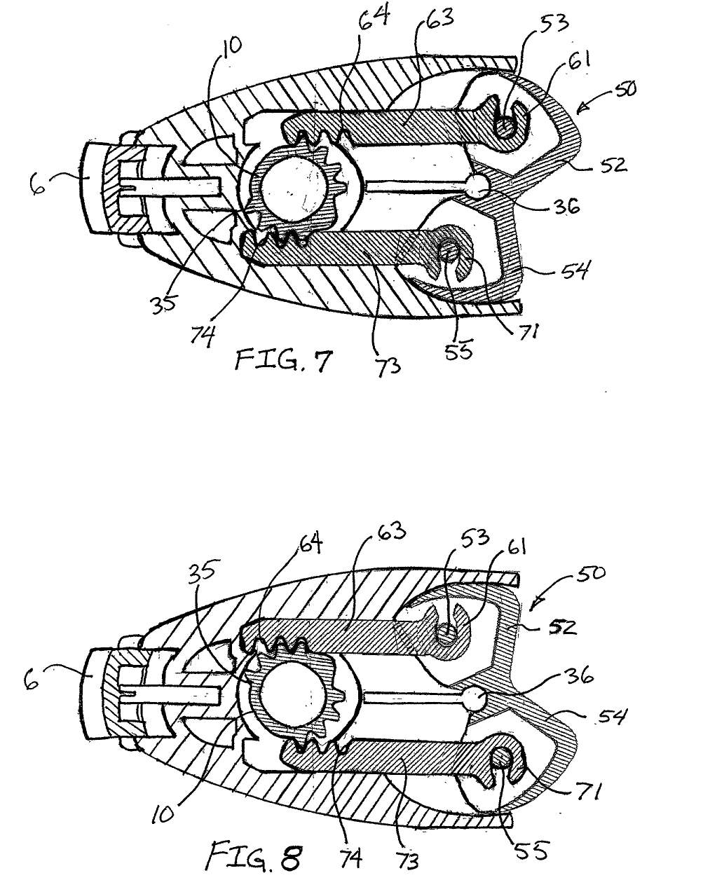

Switching of power tool 1 between a forward and reverse direction will now be explained. Upon depressing lever portion 52 to move rack portion 63 to the left with rack teeth 64 as shown in FIG. 8, rotates the rotary valve spool 10 in a counter-clockwise direction to align forward passageway 22 with forward supply port 20. Conversely, upon depressing lever portion 54 to move rack portion 73 to the left with rack teeth 74 as shown in FIG. 7, rotates the rotary valve spool 10 in a clockwise direction to align reverse passageway 23 with reverse supply port 21. The length of the rack and pinion cooperating teeth and their spacing cooperate to limit the depression excursion of the lever portions 52 and 54.

Referring to FIG. 6, rotary valve spool 10 is preferably provided with an “O” ring 26 in each of two “O” ring grooves 37 for the purposes of sealing the rack portions against intrusion of pressure fluid thereby preventing leakage to the operating rocker button.

Thus, responsive to the movement of rocker button 50, rack portions 63 and 73 move axially in a substantially perpendicular fashion to the axial rotation of the rotary valve spool 10 as it pivots about a fixed point. Due to the pivoting of rocker button 50, the point where the rocker button comes in contact with the racks changes because the shafts are moving on a fixed axes. Thus, elongated grooves 62, 72 are shaped to allow free side-to side motion of posts 53, 55 (seen best in FIGS. 3, 7, and 8) while maintaining a positive connection to permit rocker button 50 to freely move pivotally about cylindrical post 36.

Most preferably, clips 61, 71 are “C”-shaped to facilitate assembly of power tool 1. Alternatively, as shown in FIG. 12, rack portions 83 having a closed loop portions 84 with an elongated groove 82 may be utilized with a rocker button 50 comprised of two mating halves that snap-together or are otherwise attached together to form posts 53 and 55 through the closed loop portions.

In yet another embodiment, shown in FIG. 11 is a single pinion-rack assembly in which only a single-actuator rack portion 63 is attached to rocker button 50 by snapping clip 61 over post 53. Alternatively, a closed loop portion, as described above, may be used to attach the single-actuator portion to rocker button 50. These single-actuator embodiments are particularly useful in facilitating the assembly of pneumatic tool 1 while reducing the number of parts required.

Thus, a particular feature of the present invention is the control of the rotation of rotary valve spool using a single rocker button that can be easily operated with the thumb of one hand while operating the tool. Moreover, the rocker button according to the present invention may be easily manufactured using a molding operation and easily assembled to provide for economical tool manufacture.

While embodiments and applications of this invention have been shown and described, it will be apparent to those skilled in the art that many more modifications are possible without departing from the inventive concepts herein described. For example, although the rack portions and the rotary valve spool are shown and described having mating gear teeth, it is envisioned that alternate engaging mechanism such as a threaded worm-gear arrangement may be utilized.

It is understood, therefore, that the invention is capable of modification and therefore is not to be limited to the precise details set forth. Rather, various modifications may be made in the details within the scope and range of equivalents of the claims without departing from the spirit of the invention.

Having described the invention, what is claimed is:

1. A forward/reverse mechanism for a pneumatic pressure operated power tool comprising:
a rocker button having two lever portions; and
a pair of actuators disposed next to said two lever portions for engaging and rotating opposite sides of a periphery of a rotary valve spool for effecting rotation of said spool in response to movement of said rocker button.

2. A forward/reverse mechanism according to claim 1, wherein said actuators are rack portions having rack teeth.

3. A forward/reverse mechanism according to claim 1, wherein said rocker button further comprises a receiving slot located between said lever portions and configured for pivotal attachment to a cylindrical post located in a power tool.

4. A forward/reverse mechanism according to claim 1, wherein each of said lever portions further comprises a post within each lever portion.

5. A forward/reverse mechanism according to claim 4, wherein each of said rack portions further comprises a clip for removably attaching said rack portions to said posts.

6. A forward/reverse mechanism according to claim 5, wherein each of said clips is “C”-shaped and has an elongated groove for receiving said posts.

7. A forward/reverse mechanism according to claim 1, wherein said rocker button comprises two mating halves that are configured to attach to form a post within each lever portion.

8. A forward/reverse mechanism according to claim 7, wherein said rack portions each further comprises a closed loop portion with an elongated groove for receiving said posts.

9. A forward/reverse mechanism for a pneumatic pressure operated power tool comprising:
a rocker button having two lever portions; and
an actuator disposed next to one of said two lever portions for engaging and rotating opposite sides of a periphery of a rotary valve spool for effecting rotation of said spool in response to movement of said rocker button.

10. A forward/reverse mechanism according to claim 9, wherein said actuator is a rack portion having rack teeth.

11. A forward/reverse mechanism according to claim 9, wherein said lever portions are located on either side of a post receiving slot configured for attachment to a cylindrical post located in a power tool.

12. A forward/reverse mechanism according to claim 9, wherein at least one of said lever portions further comprises a post within said lever portion.

13. A forward/reverse mechanism according to claim 12, wherein said rack portion further comprises a clip for removably attaching said rack portion to said post.

14. A forward/reverse mechanism according to claim 13, wherein said clip is “C”-shaped and has an elongated groove for receiving said post.

15. A forward/reverse mechanism according to claim 9, wherein said rocker button comprises two mating halves that are configured to attach to form a post within at least one of said lever portions.

16. A forward/reverse mechanism according to claim 15, wherein said rack portion further comprises a closed loop portion with an elongated groove for receiving said post.

17. A pneumatic pressure operated power tool, comprising:
a rotary valve spool disposed in a circular passageway;
a rocker button having two lever portions; and
at least one actuator disposed next to at least one of said two lever portions for engaging and rotating opposite sides of a periphery of said rotary valve spool for effecting rotation of said spool in response to movement of said rocker button.

18. A pneumatic pressure operated power tool according to claim 17, wherein said at least one actuator is a pair of actuators disposed next to said two lever portions.

19. A pneumatic pressure operated power tool according to claim 17, wherein said power tool further comprises a cylindrical post for pivotably mounting said rocker button.

20. A pneumatic pressure operated power tool according to claim 19, wherein said rocker button further comprises a receiving slot located between said lever portions and configured for attachment to said cylindrical post.
